(19) United States
(12) Patent Application Publication
(10) Pub. No.: US 2021/0409094 A1
(43) Pub. Date: Dec. 30, 2021

(54) BEAM FAILURE RECOVERY

(71) Applicant: NEC CORPORATION, Tokyo (JP)

(72) Inventors: Fang YUAN, Beijing (CN); Lin LIANG, Beijing (CN); Gang WANG, Beijing (CN)

(73) Assignee: NEC CORPORATION, Tokyo (JP)

(21) Appl. No.: 17/290,381

(22) PCT Filed: Nov. 9, 2018
(86) PCT No.: PCT/CN2018/114909

§ 371 Date: Apr. 30, 2021

(51) Int. Cl. H04B 7/08; H04W 76/19; H04W 24/08; H04W 72/04

(52) U.S. Cl. CPC H04B 7/088; H04W 76/19; H04W 72/046; H04W 72/042; H04W 24/08

(57) ABSTRACT

Embodiments of the present disclosure relate to methods, devices and computer readable media for beam failure recovery. In example embodiments, a method implemented at a network device comprises: determining a plurality of search spaces associated with a control resource set (CORESET) configured for beam failure recovery (BFR); transmitting information on the plurality of search spaces to a terminal device served by the network device; and in response to receiving a BFR request from the terminal device, transmitting a response to the BFR request in the plurality of search spaces.

### TECHNICAL FIELD

Embodiments of the present disclosure generally relate to the field of communication, and in particular, to methods, devices and computer readable media for beam failure recovery.

### BACKGROUND

New radio access system, which is also called NR system or NR network, is the next generation communication system. Due to increased free space path loss in higher frequency band supported in NR, channel/signal transmission relies on highly directional links. In other words, directional beam based communication is needed rather than the omni-directional communication in traditional communication systems. Directional links, however, require fine alignment of the transmitter and receiver beams, achieved through a set of operations knowns as beam management. These operations can be periodically repeated to update the optimal transmitter and receiver beam pair over time.

A beam failure may occur when the quality of beam pair(s) of an associated control channel falls low enough (for example, comparison with a threshold or time-out of an associated timer). Once a beam failure is detected by a terminal device (such as, user equipment (UE)), the terminal device may identify a new candidate beam and send a beam failure recovery (BFR) request carrying information on the identified candidate beam to a network device. The terminal device may monitor a control channel search space to detect a response to the BFR request (also referred to as “BFR-response”) from the network device. Once the terminal device receives the beam recovery acknowledgement from the network device, the new beam pair can be considered to be established and the beam failure can be considered to be recovered.

In 3GPP specifications for NR, many agreements have been achieved regarding BFR. However, there still remain some open issues related to the BFR-response, which have not been specified yet.

### SUMMARY

In general, example embodiments of the present disclosure provide methods, devices and computer readable media for beam failure recovery.

In a first aspect, there is provided a method implemented at a network device. The method comprises: determining a plurality of search spaces associated with a control resource set (CORESET) configured for beam failure recovery (BFR); transmitting information on the plurality of search spaces to a terminal device served by the network device; and in response to receiving a BFR request from the terminal device, transmitting a response to the BFR request in the plurality of search spaces.

In a second aspect, there is provided a method implemented at a terminal device. The method comprises: receiving, from a network device serving the terminal device, information on a plurality of search spaces associated with a control resource set configured for beam failure recovery (BFR); in response to a beam failure being detected, transmitting a BFR request to the network device; and monitoring a response to the BFR request in the plurality of search spaces.

In a third aspect, there is provided a method implemented at a terminal device. The method comprises: determining a first set of control resource sets (CORESETs) and a first set of search space (SS) monitoring occasions associated with the first set of CORESETs configured for the terminal device to monitor Physical Downlink Control Channel (PDCCH); in response to a plurality of SS monitoring occasions from the first set of SS monitoring occasions being overlapped in time and associated with different CORESETs, determining, from the first set of SS monitoring occasions, a second set of SS monitoring occasions by applying a dropping rule to the plurality of SS monitoring occasions, the second set of SS monitoring occasions being associated with a second set of CORESETs included in the first set of CORESETs; in response to a time offset between reception of the PDCCH and reception of Physical Downlink Shared Channel (PDSCH) corresponding to the PDCCH being below a predetermined threshold, selecting a CORESET from the second set of CORESETs; and determining a beam for the reception of the PDSCH based on the selected CORESET.

In a fourth aspect, there is provided a method implemented at a terminal device. The method comprises: in response to a beam failure being detected, transmitting a beam failure recovery (BFR) request in a first slot via a first beam to a network device serving the terminal device; determining a second beam for downlink (DL) reception prior to a new beam for DL reception being configured by the network device; and performing the DL reception via the second beam prior to the new beam for DL reception being configured by the network device and subsequent to a second slot which is later than the first slot by a predetermined number of slots.

In a fifth aspect, there is provided a method implemented at a terminal device. The method comprises: in response to a beam failure being detected, transmitting a beam failure recovery (BFR) request via a first beam to a network device serving the terminal device; determining, based on first latency for decoding a response to the BFR request and second latency for beam switching and/or data preparation, a time duration required for switching an uplink (UL) beam for UL transmission; in response to receiving the response to the BFR request from the network device, waiting for at least the time duration; and switching the uplink (UL) beam for UL transmission from a previous beam configured by the network device to be the first beam.

In a sixth aspect, there is provided a network device. The device comprises a processor and a memory coupled to the processor. The memory stores instructions that when executed by the processor, cause the device to perform the method according to the first aspect of the present disclosure.

In a seventh aspect, there is provided a terminal device. The device comprises a processor and a memory coupled to the processor. The memory stores instructions that when executed by the processor, cause the device to perform the method according to the second aspect of the present disclosure.

In an eighth aspect, there is provided a terminal device. The device comprises a processor and a memory coupled to the processor. The memory stores instructions that when executed by the processor, cause the device to perform the method according to the third aspect of the present disclosure.

In a ninth aspect, there is provided a terminal device. The device comprises a processor and a memory coupled to the processor. The memory stores instructions that when executed by the processor, cause the device to perform the method according to the fourth aspect of the present disclosure.

In a tenth aspect, there is provided a terminal device. The device comprises a processor and a memory coupled to the processor. The memory stores instructions that when executed by the processor, cause the device to perform the method according to the fifth aspect of the present disclosure.

In a eleventh aspect, there is provided a computer readable medium having instructions stored thereon, the instructions, when executed on at least one processor, causing the at least one processor to carry out the method according to the first aspect of the present disclosure.

In a twelfth aspect, there is provided a computer readable medium having instructions stored thereon, the instructions, when executed on at least one processor, causing the at least one processor to carry out the method according to the second aspect of the present disclosure.

In a thirteenth aspect, there is provided a computer readable medium having instructions stored thereon, the instructions, when executed on at least one processor, causing the at least one processor to carry out the method according to the third aspect of the present disclosure.

In a fourteenth aspect, there is provided a computer readable medium having instructions stored thereon, the instructions, when executed on at least one processor, causing the at least one processor to carry out the method according to the fourth aspect of the present disclosure.

In a fifteenth aspect, there is provided a computer readable medium having instructions stored thereon, the instructions, when executed on at least one processor, causing the at least one processor to carry out the method according to the fifth aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates a schematic diagram of a communication environment in which embodiments of the present disclosure can be implemented;

FIG. 2 illustrates a process for BFR in accordance with some embodiments of the present disclosure;

FIGS. 3A and 3B show examples of a plurality of search spaces associated with the BFR-CORESET in accordance with some embodiments of the present disclosure;

FIG. 4 illustrates a flowchart of an example method in accordance with some embodiments of the present disclosure;

FIG. 5 illustrates a flowchart of an example method in accordance with some embodiments of the present disclosure;

FIG. 6 illustrates a flowchart of an example method in accordance with some embodiments of the present disclosure;

FIG. 7 illustrates a flowchart of an example method in accordance with some embodiments of the present disclosure;

FIGS. 8A and 8B show examples of a default beam for PDSCH reception in accordance with some embodiments of the present disclosure;

FIG. 9 illustrates a flowchart of an example method in accordance with some embodiments of the present disclosure;

FIG. 10 shows an example of a default beam for PDSCH reception in accordance with some embodiments of the present disclosure;

FIG. 11 illustrates an example of some embodiments of the present disclosure;

FIG. 12 illustrates a flowchart of an example method in accordance with some embodiments of the present disclosure;

FIG. 13 illustrates timing for switching a beam for UL transmission in accordance with some embodiments of the present disclosure;

FIG. 14 illustrates a flowchart of an example method in accordance with some embodiments of the present disclosure; and

FIG. 15 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “at least in part based on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As mentioned above, a beam failure may occur when the quality of beam pair(s) of an associated control channel falls low enough (for example, comparison with a threshold or time-out of an associated timer). Once a beam failure is detected by a terminal device (such as, user equipment (UE)), the terminal device may identify a new candidate beam and send a beam failure recovery (BFR) request carrying information on the identified candidate beam to a network device. The terminal device may monitor a control channel search space to detect a response to the BFR request (also referred to as “BFR-response”) from the network device. Once the terminal device receives the beam recovery acknowledgement from the network device, the new beam pair can be considered to be established and the beam failure can be considered to be recovered.

In 3GPP specifications for NR, many agreements have been achieved regarding BFR. However, there still remain some open issues related to the BFR-response, which have not been specified. Embodiments of the present disclosure identify these issues and provide a solution for BFR, so as to solve these issues and one or more of other potential problems. As such, embodiments of the present disclosure enable improved BFR support for NR.

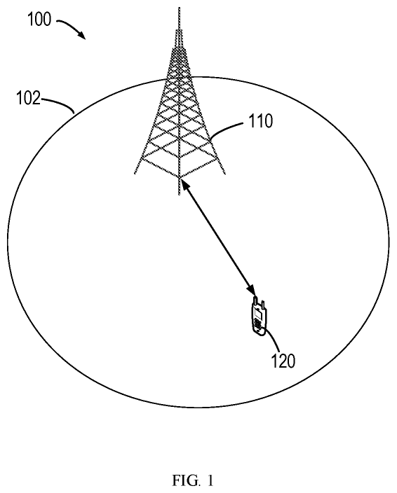

Principle and implementations of the present disclosure will be described in detail below with reference to FIGS. 1-15.

FIG. 1 shows an example communication network 100 in which embodiments of the present disclosure can be implemented. The network 100 includes a network device 110 and a terminal device 120 served by the network device 110. The network 100 may provide one or more serving cells 102 to serve the terminal device 120. It is to be understood that the number of network devices, terminal devices and/or serving cells is only for the purpose of illustration without suggesting any limitations to the present disclosure. The network 100 may include any suitable number of network devices, terminal devices and/or serving cells adapted for implementing implementations of the present disclosure.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, image capture devices such as digital cameras, gaming devices, music storage and playback appliances, or Internet appliances enabling wireless or wired Internet access and browsing and the like. For the purpose of discussion, in the following, some embodiments will be described with reference to UE as an example of the terminal device 120.

As used herein, the term “network device” or “base station” (BS) refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Remote Radio Unit (RRU), a radio head (RH), a remote radio head (RRH), a low power node such as a femto node, a pico node, and the like.

For example, in some scenarios, carrier aggregation (CA) can be supported in the network 100, in which two or more component carriers (CCs) are aggregated in order to support a broader bandwidth. In CA, the network device 110 may provide a plurality of serving cells (for example, one for each of the CCs) including one primary cell (PCell) and at least one Secondary Cell (Scell) to serve the terminal device 120. The terminal device 120 can establish Radio Resource Control (RRC) connection with the network device 110 in the Pcell. The Scell can provide additional radio resources once the RRC connection between the network device 110 and the terminal device 120 is established and the Scell is activated via higher layer signaling.

In some other scenarios, for example, the terminal device 120 may establish connections with two different network devices (not shown in FIG. 1) and thus can utilize radio resources of the two network devices. The two network devices may be respectively defined as a master network device and a secondary network device. The master network device may provide a group of serving cells, which are also referred to as “Master Cell Group (MCG)”. The secondary network device may also provide a group of serving cells, which are also referred to as “Secondary Cell Group (SCG)”. For Dual Connectivity operation, a term “Special Cell (SpCell)” may refer to the Pcell of the MCG or the primary Scell (PScell) of the SCG depending on if the terminal device 120 is associated to the MCG or the SCG, respectively. In other cases than the Dual Connectivity operation, the term “SpCell” may also refer to the Pcell.

In the communication network 100 as shown in FIG. 1, the network device 110 can communicate data and control information to the terminal device 120 and the terminal device 120 can also communication data and control information to the network device 110. A link from the network device 110 to the terminal device 120 is referred to as a downlink (DL), while a link from the terminal device 120 to the network device 110 is referred to as an uplink (UL).

The communications in the network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

The network device 110 may communicate data and control information to the terminal device 120 via a plurality of beams (also referred to as “DL beams”). The terminal device 120 can also communication data and control information to the network device 110 via a plurality of beams (also referred to as “UL beams”). In 3GPP specifications for NR, a beam is also defined and indicated by parameters of a transmission control indicator (TCI). A beam failure may occur if the network device 110 is no longer able to reach the terminal device 120 via a control channel (such as, Physical Downlink Control Channel (PDCCH)) due to incorrect adjustment of the beams, blockage effect, movement of the terminal device 120, or some other reasons. For example, the terminal device 120 may detect this situation by estimating the quality of a hypothetical PDCCH reception transmitted over a beam that the network device 110 would use to reach the terminal device 120. A mechanism to recover from a beam failure may be triggered when the beam failure occurs. The beam failure recovery mechanism on terminal device side usually includes the following operations: beam failure detection, identification of a new beam, transmission of a beam failure recovery request and monitoring a response to the beam failure recovery request from the network device.

In 3GPP specifications for NR, many agreements have been achieved regarding BFR. For example, the BFR procedure has been specified as follows: (a) a terminal device initiates a dedicated PRACH transmission to a network device on contention-free physical random access channel (CFRA) as the BFR request, and the PRACH preamble index is associated with a new candidate beam index identified by the terminal device; and (b) after receiving the PRACH transmission, the network device sends a BFR-response on a dedicated control resource set (also referred to as “BFR-CORESET”) to the terminal device, and the terminal device shall monitor BFR-CORESET for the BFR-response.

As used herein, a “CORESET” refers to a frequency resource within which the terminal device attempts to blindly decode downlink control information (DCI). In response to decoding the DCI successfully, the terminal device may perform UL data transmission and/or DL data reception (for example, data transmission via PDSCH and/or Physical Uplink Shared Channel (PUSCH)) with the network device based on the decoded DCI. It has been agreed that the BFR-response is transmitted via a PDCCH addressed to cell-Radio Network Temporary Identifier (C-RNTI). It has also been agreed that a time window and a BFR-CORESET can be configured via higher layer signaling for the terminal device to monitor the BFR-response. The terminal device may assume that the dedicated CORESET (that is, the BFR-CORESET) is spatial quasi co-locationed with DL RS of the new candidate beam identified by the terminal device in the BFR request.

A terminal device can be provided with a CORESET through a link to a search space set provided by higher layer parameter recoverySearchSpaceId for monitoring PDCCH in the CORESET. As used herein, a “search space” may indicate the start time and a periodicity for monitoring PDCCH, which is allocated with a set of control resource elements (CCE) and is associated with a CORESET. If the terminal device is provided with the higher layer parameter recoverySearchSpaceId, the terminal device may not expect to be provided another search space set for monitoring PDCCH in the CORESET associated with the search space set provided by recoverySearchSpaceId.

A search space associated with a CORESET can be a common search space (CSS) or a UE-specific search space. The CSS can be used for monitoring DCI in DCI formats 0_0 and 1_0, while the USS can be configured for either monitoring DCI in DCI formats 0_1 and 1_1 only or DCI in DCI formats 0_0 and 1_0 only. DCI formats 0_0 and 1_0 have no field for triggering channel measurements, such as requesting Channel State Information (CSI)/Sounding Reference Signal (SRS) transmission and report, which is important for BFR. This is because the BFR request only provides the new beam identifier without providing quality of the beam. In addition, the network device is not sure whether the previously configured beam is valid or not. Although persistent/semi-persistent CSI/SRS can be used for channel measurement if only DCI in DCI formats 0_0 and 1_0 can be monitored, this may result in some delay.

It can be seen that, in current 3GPP specifications, the BFR-CORESET is associated with only one search space. That is, the BFR-CORESET may be associated with either a CSS or a USS. In this event, limited DCI formats can be monitored and channel measurement will be restricted. Apparently, this may affect the flexibility and efficiency of BFR.

In some embodiments of the present disclosure, a plurality of search spaces associated with the BFR-CORESET can be supported. In this way, the flexibility and efficiency of BFR can be improved.

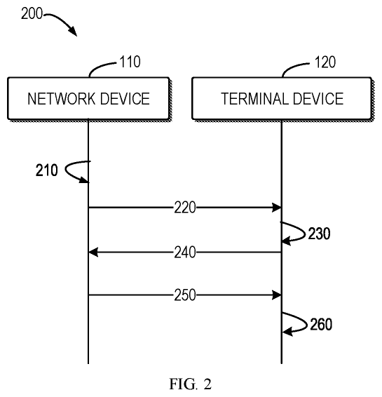

FIG. 2 illustrates a process 200 for BFR according to some embodiments of the present disclosure. For the purpose of discussion, the process 200 will be described with reference to FIG. 1. The process 200 may involve the network device 110 and the terminal devices 120 served by the network device 110.

As shown in FIG. 2, the network device 110 determines 210 a plurality of search spaces associated with a CORESET configured for BFR (that is, BFR-CORESET). In the following, a search space associated with the BFR-CORESET can also be referred to as a “BFR-SS”.

In some embodiments, the plurality of search spaces may include a first search space and a second search space. The first search space and the second search space may have different time periodicities, different time offsets and/or different set of CCEs. As used herein, the “time offset” of a search space refers to the starting position of the search space in one period.

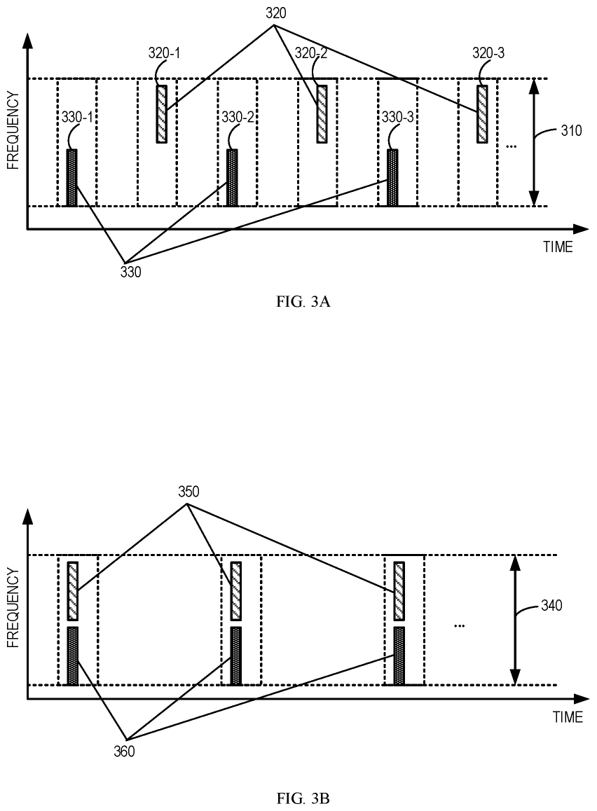

FIGS. 3A and 3B show examples of the plurality of search spaces associated with the BFR-CORESET according to some embodiments of the present disclosure. As shown in FIG. 3A, two search spaces 320 and 330 are associated with a BFR-CORESET 310. Each of the search spaces 320 and 330 may have a plurality of monitoring occasions. For example, the search space 320 has monitoring occasions 320-1, 320-2, 320-3 . . . and so on. The search space 330 has monitoring occasions 330-1, 330-2, 330-3 . . . and so on. It can be seen from FIG. 3A that the search spaces 320 and 330 are associated with different sets of CCEs. Moreover, the search spaces 320 and 330 have different time periodicities and/or different time offsets. As shown in FIG. 3B, two search spaces 350 and 360 are associated with a BFR-CORESET 340. The search spaces 350 and 360 are associated with different sets of CCEs but have the same time periodicity and time offset.

In some embodiments, each of the plurality of search spaces associated with the BFR-CORESET may be either a CSS or a USS. The CSS may be used for monitoring DCI in DCI formats 0_0 and 1_0, while the USS may be configured for monitoring DCI in DCI formats 0_1 and 1_1 only or DCI in DCI formats 0_0 and 1_0 only. For example, in case that the plurality of search spaces associated with the BFR-CORESET include a first search space (also referred to as “BFR-SS 1”) and a second speech space (also referred to as “BFR-SS 2”), the configurations of BFR-SS 1 and BFR-SS 2 can be shown as Table 1.

TABLE 1
Configurations of BFR-SSs

| Index | BFR-SS 1 | BFR-SS 2 |
|---|---|---|
| #1 | CSS: | USS: |
| | DCI format 0_0/1_0 | DCI format 0_1/1_1 |
| #2 | USS: | USS: |
| | DCI format 0_0/1_0 | DCI format 0_1/1_1 |
| #3 | CSS: | N/A |
| | DCI format 0_0/1_0 | |
| #4 | N/A | USS: |
| | | DCI format 0_1/1_1 |
| #5 | N/A | USS: |
| | | DCI format 0_0/1_0 |

It is to be understood that, the example configurations of BFR-SS 1 and BFR-SS 2 as shown in Table 1 are merely for the purpose of illustration, without suggesting any limitation to the scope of the present disclosure. In other embodiments, the plurality of search spaces associated with the BFR-CORESET may include more than two search spaces, each of which can be either a CSS for monitoring DCI format 0_0/1_0 or a USS for monitoring DCI format 0_1/1_1 or 0_0/1_0. The scope of the present disclosure is not limited in this aspect.

In some embodiments, the network device 110 may provide a plurality of serving cells to serve the terminal device 120. For example, the plurality of serving cells may include a Pcell and an Scell. In some embodiments, only one USS for monitoring DCI format 0_0/1_0 may be configured as the BFR-SS on the Scell, which is used for responding to the BFR of Scell. Additionally, a CSS for monitoring DCI format 0_0/1_0 and/or a USS for monitoring DCI format 0_1/1_1 or 0_0/1_0 can be configured as the BFR-SS(s) on the PCell, which is used for responding to the BFR of Pcell. In case that a USS for monitoring DCI format 0_0/1_0 is configured as the BFR-SS on the PCell, the function of channel measurement on Scell can be triggered by DCI of DCI format 0_1/1_1 transmitted on the PCell.

With reference back to FIG. 2, the network device 110 transmits 220 information on the plurality of search spaces associated with the BFR-CORESET to the terminal device 120 served by the network device 110.

In some embodiments, the information may indicate respective time periodicities, respective time offsets, respective sets of CCEs, respective types (such as, CSS or USS) and/or the like associated with the plurality of BFR-SSs. In some embodiments, the network device 110 may transmit the information on the plurality of BFR-SSs to the terminal device 120 via higher layer signaling (such as, Radio Resource Control (RRC) and/or Medium Access Control (MAC) Control Element (CE)).

In response to receiving the information about the plurality of search spaces associated with the BFR-CORESET, the terminal device 120 detects 230 whether a beam failure occurs. In response to a beam failure being detected, the terminal device 120 identifies a new candidate beam and transmits 240 a BFR request carrying information on the identified candidate beam to the network device 110.

In response to receiving the BFR request from the terminal device 120, the network device 110 transmits 250 a response to the BFR request in the plurality of BFR-SSs.

In some embodiments, the plurality of BFR-SSs may include a CSS and a USS. The network device 110 may transmit a response to the BFR request in DCI format 0_0/1_0 in the CSS. Additionally, the network device 110 may transmit the response to the BFR request in DCI format 0_0/1_0 or DCI format 0_1/1_1 in the USS. Alternatively, in some embodiments, the plurality of BFR-SSs may include a first USS and a second USS. The network device 110 may transmit a response to the BFR request in DCI format 0_0/1_0 in the first USS, and transmit the response to the BFR request in DCI format 0_1/1_1 in the second USS.

Accordingly, the terminal device 120 may monitor 260 the response to the BFR request in the plurality of search spaces.

In some embodiments, the plurality of BFR-SSs may include a CSS and a USS. The terminal device 120 may monitor a response to the BFR request in DCI format 0_0/1_0 in the CSS. Additionally, the terminal device 120 may monitor the response to the BFR request in DCI format 0_0/1_0 or DCI format 0_1/1_1 in the USS. Alternative, in some embodiments, the plurality of BFR-SSs may include a first USS and a second USS. The terminal device 120 may monitor a response to the BFR request in DCI format 0_0/1_0 in the first USS, and monitor the response to the BFR request in DCI format 0_1/1_1 in the second USS.

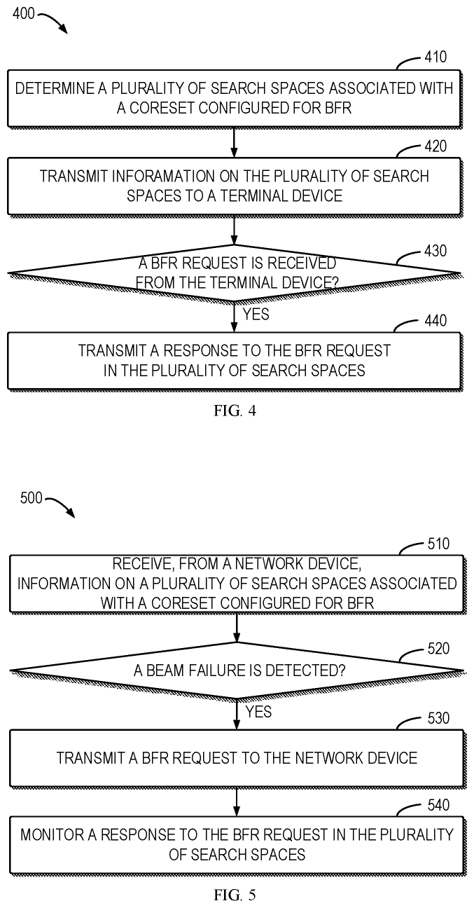

FIG. 4 illustrates a flowchart of an example method 400 for BFR according to some embodiments of the present disclosure. The method 400 can be implemented at the network device 110 as shown in FIGS. 1-2. It is to be understood that the method 400 may include additional blocks not shown and/or may omit some blocks as shown, and the scope of the present disclosure is not limited in this regard. For the purpose of discussion, the method 400 will be described from the perspective of the network device 110 with reference to FIGS. 1-2.

At block 410, the network device 110 determines a plurality of search spaces associated with a CORESET configured for BFR.

In some embodiments, the plurality of search spaces include a first search space and a second search space. In some embodiments, the first search space is one of a CSS and a USS, and the second search space is a USS.

In some embodiments, the plurality of search spaces are associated with different time periodicities, different time offsets and/or different sets of CCEs.

At block 420, the network device 110 transmits information on the plurality of search spaces to the terminal device 120 served by the network device 110.

In some embodiments, the plurality of search spaces include a first search space. The network device 110 may transmit first information on the first search space to the terminal device 120. The first information may indicate at least one of a first time periodicity, a first time offset and a first set of control channel elements associated with the first search space.

At block 430, the network device 110 determines if a BFR request is received from the terminal device 120.

At block 440, in response to receiving a BFR request from the terminal device 120, the network device 110 transmits a response to the BFR request in the plurality of search spaces.

In some embodiments, the plurality of search spaces include a CSS and a USS. The network device 110 may transmit a response to the BFR request in a first DCI format in the CSS, and transmit the response to the BFR request in a second DCI format in the USS. In some embodiments, the first DCI format is one of DCI format 0_0 and DCI format 1_0. The second DCI format is one of DCI format 0_0 and DCI format 1_0, or one of DCI format 0_1 and DCI format 1_1.

In some embodiments, the plurality of search spaces include a first USS and a second USS. The network device 110 may transmit a response to the BFR request in a third DCI format in the first USS, and transmit the response to the BFR request in a fourth DCI format in the second USS. In some embodiments, the third DCI format is one of DCI format 0_0 and DCI format 1_0, and the fourth DCI format is one of DCI format 0_1 and DCI format 1_1.

FIG. 5 illustrates a flowchart of an example method 500 for BFR according to some embodiments of the present disclosure. The method 500 can be implemented at the terminal device 120 as shown in FIGS. 1-2. It is to be understood that the method 500 may include additional blocks not shown and/or may omit some blocks as shown, and the scope of the present disclosure is not limited in this regard. For the purpose of discussion, the method 500 will be described from the perspective of the terminal device 120 with reference to FIGS. 1-2.

At block 510, the terminal device 120 receives, from the network device 110 serving the terminal device 120, information on a plurality of search spaces associated with a CORESET configured for BFR.

In some embodiments, the plurality of search spaces include a first search space and a second search space. In some embodiments, the first search space is one of a CSS and a USS, and the second search space is a USS.

In some embodiments, the plurality of search spaces are associated with different time periodicities, different time offsets and/or different sets of CCEs.

In some embodiments, the plurality of search spaces include a first search space. The terminal device 120 may receive first information on the first search space from the network device 110. The first information may indicate at least one of a first time periodicity, a first time offset and a first set of control channel elements associated with the first search space.

At block 520, the terminal device 120 determines if a beam failure is detected.

At block 530, in response to a beam failure being detected, the terminal device 120 transmits a BFR request to the network device 110.

At block 540, the terminal device 120 monitors a response to the BFR request in the plurality of search spaces.

In some embodiments, the plurality of search spaces include a CSS and a USS. The terminal device 120 may monitor a response to the BFR request in a first DCI format in the CSS, and monitor the response to the BFR request in a second DCI format in the USS. In some embodiments, the first DCI format is one of DCI format 0_0 and DCI format 1_0. The second DCI format is one of DCI format 0_0 and DCI format 1_0, or one of DCI format 0_1 and DCI format 1_1.

In some embodiments, the plurality of search spaces include a first USS and a second USS. The terminal device 120 may monitor a response to the BFR request in a third DCI format in the first USS, and monitor the response to the BFR request in a fourth DCI format in the second USS. In some embodiments, the third DCI format is one of DCI format 0_0 and DCI format 1_0, and the fourth DCI format is one of DCI format 0_1 and DCI format 1_1.

As described above, the terminal device may attempt to blindly decode DCI transmitted in one or more CORESETs. The CORESETs may be different from the BFR-CORESET. In response to decoding the DCI successfully, the terminal device may perform UL and/or DL data transmission (for example, PDSCH and/or PUSCH transmission) based on the decoded DCI. For example, the DL DCI may indicate a beam for reception of the PDSCH. However, in some cases, PDSCH may be scheduled subsequent to the DCI reception but prior to DCI being successfully decoded. In this event, the terminal device may need to determine a default beam for PDSCH reception.

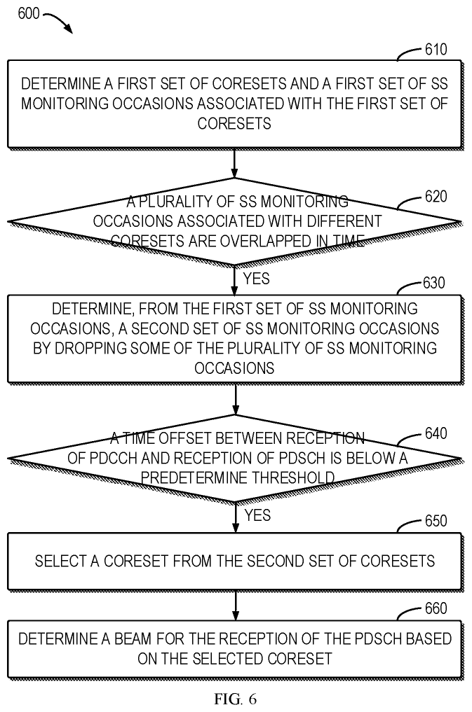

FIG. 6 illustrates a flowchart of an example method 600 for determining a default PDSCH beam according to some embodiments of the present disclosure. The method 600 can be implemented at the terminal device 120 as shown in FIG. 1. It is to be understood that the method 600 may include additional blocks not shown and/or may omit some blocks as shown, and the scope of the present disclosure is not limited in this regard. For the purpose of discussion, the method 600 will be described from the perspective of the terminal device 120 with reference to FIG. 1.

At block 610, the terminal device 120 determines a first set of CORESETs and a first set of search space (SS) monitoring occasions associated with the first set of CORESETs configured for the terminal device 120 to monitor PDCCH. For example, the first set of CORESETs and the first set of SSs associated with the first set of CORESETs may be configured by the network device 110.

At block 620, the terminal device 120 determines if a plurality of SS monitoring occasions from the first set of SS monitoring occasions associated with different CORESETs are overlapped in time.

At block 630, in response to the plurality of SS monitoring occasions associated with different CORESETs being overlapped in time, the terminal device 120 may determine, from the first set of SS monitoring occasions, a second set of SS monitoring occasions by dropping some search spaces from the plurality of SS monitoring occasions. For example, the second set of SS monitoring occasions are associated with a second set of CORESETs included in the first set of CORESETs.

In some embodiments, a dropping rule can be applied to the plurality of SS monitoring occasions, so as to obtain the second set of SS monitoring occasions from the first set of SS monitoring occasions. The terminal device 120 may monitor only a search space in a CORESET, and in any other CORESET from the multiple CORESETs having same QCL-TypeD properties as the CORESET, on the active DL BWP of a cell with the lowest index from the one or more cells that corresponds to the CSS set with the lowest index, if any; otherwise, to the USS set with the lowest index. For example, if the plurality of SS monitoring occasions are overlapped in time and associated with different CORESETs having different QCL-TypeD properties, the terminal device 120 may monitor search spaces associated with a given CORESET containing a CSS in the active DL Bandwidth Part (BWP) in the serving cell with the lowest serving cell index and any other CORESET associated with the same QCL-TypeD properties as the given CORESET. If two or more CORESETs each contain a CSS, the terminal device 120 may select the CORESET containing the SS having the lowest ID among the SS monitoring occasions in the active DL BWP in the serving cell with the lowest serving cell index. Additionally, any overlapped search space(s) associated with CORESET(s) having the same QCL-TypeD properties may be monitored by the terminal device 120. If none of the CORESETs contains a CSS, the terminal device 120 may select the CORESET containing the search space having the lowest ID among the SS monitoring occasions in the active DL BWP in the serving cell with the lowest serving cell index. Additionally, any overlapped search space(s) associated with CORESET(s) having the same QCL-TypeD properties may be monitored by the terminal device 120. Additionally, QCL TypeD with respect to different RSs may be considered as different QCL-TypeD properties. As such, the terminal device 120 can obtain the second set of SS monitoring occasions from the first set of SS monitoring occasions by dropping some search spaces from the plurality of SS monitoring occasions overlapped in time.

At block 640, the terminal device 120 determines if a time offset between reception of the PDCCH and reception of Physical Downlink Shared Channel (PDSCH) corresponding to the PDCCH is below a predetermined threshold. The predetermined threshold may be defined as “Threshold-Sched-Offset” in 3GPP specifications, which is a UE capability based on how fast the terminal device can decode DCI and update the beam successfully.

At block 650, in response to the time offset being blow the predetermined threshold, the terminal device 120 selects a CORESET from the second set of CORESETs. Then, at block 660, the terminal device 120 determines a beam for the reception of the PDSCH based on the selected CORESET.

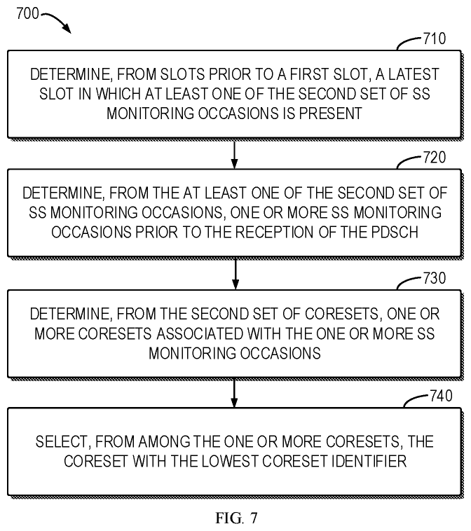

FIG. 7 illustrates a flowchart of an example method 700 for selecting a CORESET from the second set of CORESETs according to some embodiments of the present disclosure. The method 700 can be considered as an example implementation of the block 650 as shown in FIG. 6.

At block 710, the terminal device 120 determines, from slot prior to a first slot in which the PDSCH is to be received prior to downlink control information being decoded, a latest slot in which at least one of the second set of SS monitoring occasions is present.

At block 720, the terminal device 120 determines, from the at least one of the second set of SS monitoring occasions, one or more SS monitoring occasions prior to the reception of the PDSCH.

At block 730, the terminal device 120 determines, from the second set of CORESETs, one or more CORESETs associated with the one or more SS monitoring occasions.

At block 740, the terminal device 120 selects, from among the one or more CORESETs, the CORESET with the lowest CORESET identifier.

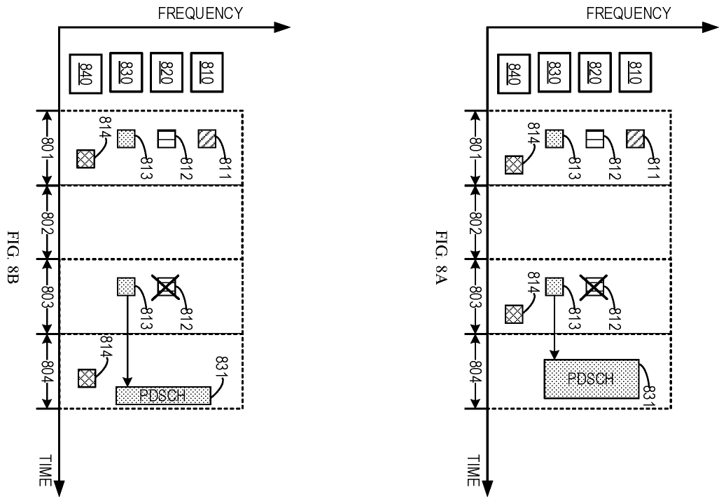

FIG. 8A shows an example of the default PDSCH beam according to some embodiments of the present disclosure. As shown in FIG. 8A, four CORESETs 810, 820, 830 and 840 are configured, each associated with a respective search space. The first set of CORESETs therefore include the CORESETs 810, 820, 830, and 840. For example, the CORESET 810 is associated with a search space 811. The CORESET 820 is associated with a search space 812. The CORESET 830 is associated with a search space 813. The search spaces 812 and 813 have the same time periodicity and time offset, while the search space 811 has a different time periodicity. The CORESET 840 is associated with a search space 814, which has the same time periodicity as the search spaces 812 and 813 but has a different time offset.

As shown in FIG. 8A, in a slot 801, monitoring occasions of the search spaces 811, 812 and 813 are overlapped in time. In a slot 803, only the search spaces 812 and 813 have monitoring occasions, which are overlapped in time, while the search spaces 814 is not overlapped with the other two. PDSCH 831 is to be received in a slot 804 when DCI may have not been decoded. Additionally, no SS monitoring occasion is present in the slot 804. In this case, the dropping rule may be applied to monitoring occasions of the search spaces which are overlapped in time and associated with different CORESETs. For example, if search space 812 is a USS and search space 813 is CSS, the priority of the search space 812 may be lower than that of the search space 813, and thus will be dropped by the terminal device in the slot 803, although the CORESET 820 has a lower identifier than the CORESET 830. That is, the terminal device may not monitor the search space 812 no matter whether the network device transmits DCI in the search space 812 or not. Therefore, the second set of CORESETs include the CORESETs 830 and 840. The terminal device may firstly determine, from slots prior to the slot 804 in which PDSCH 831 is to be received prior to DCI being decoded, a latest slot (that is, the slot 803) in which at least one SS monitoring occasions is present. Since the CORESET 830 with the monitoring occasion of the search space 813 in the slot 803 has the lowest identifier in the second set of CORESETs, the terminal device may determine a beam for reception of PDSCH 831 based on a beam of the CORESET 830 associated with the search space 813.

According to some embodiments of the present disclosure, the solution for determining the default PDSCH beam can be specified as below: if the offset between the reception of the DL DCI and the corresponding PDSCH is less than a threshold Threshold-Sched-Offset, the terminal device may assume that the Demodulation Reference Signal (DM-RS) ports of PDSCH of a serving cell are quasi co-located with the RS(s) in the Transmission Control Indicator (TCI) state with respect to the quasi co-location (QCL) parameter(s) used for PDCCH QCL indication of the lowest CORESET-ID in the latest slot in which one or more CORESETs within the active BWP of the serving cell are configured for the terminal device with monitoring occasions of search space after applying a search space dropping rule if needed. In this case, if the ‘QCL-TypeD’ of the PDSCH DM-RS is different from that of the PDCCH DM-RS with which they overlap in at least one symbol, the terminal device is expected to prioritize the reception of PDCCH associated with that CORESET. This also applies to the intra-band CA case (when PDSCH and the CORESET are in different component carriers).

FIG. 8B shows another example of the default PDSCH beam according to some embodiments of the present disclosure. Same as FIG. 8A, four CORESETs 810, 820, 830 and 840 are configured, each associated with a respective search space. The first set of CORESETs therefore include the CORESETs 810, 820, 830, and 840. For example, the CORESET 810 is associated with a search space 811. The CORESET 820 is associated with a search space 812. The CORESET 830 is associated with a search space 813. The search spaces 812 and 813 have the same time periodicity and time offset, while the search space 811 has a different time periodicity.

Different from FIG. 8A, in FIG. 8B, the CORESET 840 is associated with a search space 814, which has a different time periodicity and a different time offset from the search spaces 812 and 813. As shown in FIG. 8B, in a slot 801, monitoring occasions of the search spaces 811, 812 and 813 are overlapped in time. In a slot 803, only the search spaces 812 and 813 have monitoring occasions, which are overlapped in time. PDSCH 831 is to be received in a slot 804 when DCI may have not been decoded. Additionally, the search space 814 has a monitoring occasion in the slot 804. In this case, the dropping rule may be applied to monitoring occasions of the search spaces which are overlapped in time and associated with different CORESETs. For example, the priority of the search space 812 may be lower than that of the search space 813, and thus will be dropped by the terminal device in the slot 803. That is, the terminal device may not monitor the search space 812 no matter whether the network device transmits DCI in the search space 812 or not. Therefore, the second set of CORESETs include the CORESETs 830 and 840. The terminal device may firstly determine, from slots prior to the slot 804 in which PDSCH 831 is to be received prior to DCI being decoded, a latest slot (that is, the slot 803) in which at least one SS monitoring occasions is present. Since the CORESET 830 with the monitoring occasion of the search space 813 in the slot 803 has the lowest identifier in the second set of CORESETs, the terminal device may determine a beam for reception of PDSCH 831 based on a beam of the CORESET 830 associated with the search space 813, instead of that of the CORESET 840 associated with the search space 814.

According to some embodiments of the present disclosure, the solution for determining the default PDSCH beam a can be alternatively specified as below: if the offset between the reception of the DL DCI and the corresponding PDSCH is less than a threshold Threshold-Sched-Offset, the terminal device may assume that the DM-RS ports of PDSCH of a serving cell are quasi co-located with the RS(s) in the TCI state with respect to the QCL parameter(s) used for PDCCH QCL indication of the lowest CORESET-ID in the latest slot before the slot of PDSCH reception in which one or more CORESETs within the active BWP of the serving cell are configured for the terminal device with monitoring occasions of search space after applying a search space dropping rule if needed. In this case, if the ‘QCL-TypeD’ of the PDSCH DM-RS is different from that of the PDCCH DM-RS with which they overlap in at least one symbol, the terminal device is expected to prioritize the reception of PDCCH associated with that CORESET. This also applies to the intra-band CA case (when PDSCH and the CORESET are in different component carriers).

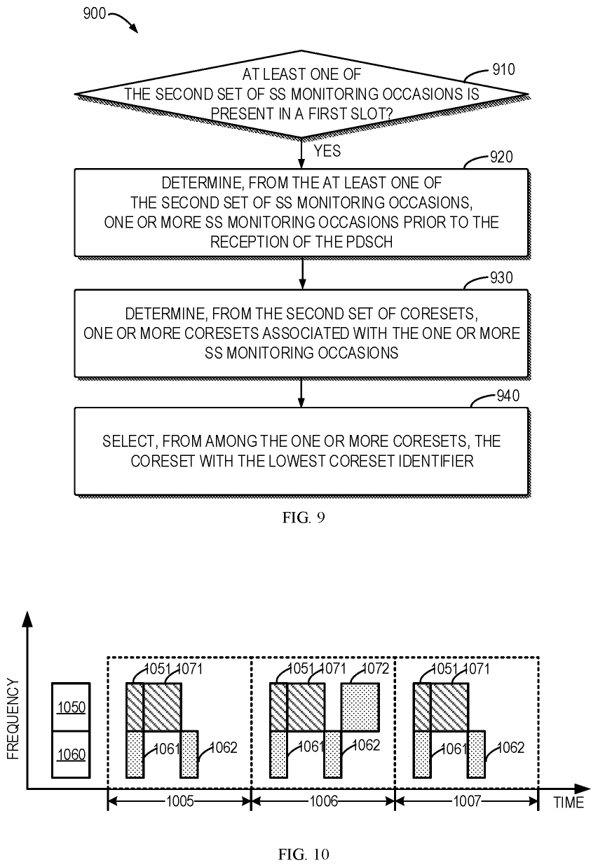

FIG. 9 illustrates a flowchart of an example method 900 for selecting a CORESET from the second set of CORESETs according to some embodiments of the present disclosure. The method 900 can be considered as an example implementation of the block 650 as shown in FIG. 6.

At block 910, the terminal device 120 determines whether at least one of the second set of SS monitoring occasions is present in a first slot in which the PDSCH is to be received prior to DCI being decoded.

In response to determining that at least one of the second set of SS monitoring occasions is present in the first slot, at block 920, the terminal device 120 determines, from the at least one of the second set of SS monitoring occasions, one or more SS monitoring occasions prior to the reception of the PDSCH.

At block 930, the terminal device 120 determines, from the second set of CORESETs, one or more CORESETs associated with the one or more SS monitoring occasions.

At block 940, the terminal device 120 selects, from among the determined one or more CORESETs, the CORESET with the lowest CORESET identifier.

FIG. 10 shows an example of the default PDSCH beam according to some embodiments of the present disclosure. As shown in FIG. 10, two CORESETs 1050 and 1060 are configured. For example, the CORESET 1050 is associated with a search space 1051. The CORESET 1060 is associated with search spaces 1061 and 1062. The search spaces 1051 and 1061 have the same time periodicity and time offset. The search spaces 1061 and 1062 are associated with the same set of CCEs but have different time offsets. As shown in FIG. 10, monitoring occasions of the search spaces 1051 and 1061 are overlapped in time in slots 1005, 1006 and 1007. PDSCH is to be received in the slot 1006 when DCI may have not been decoded. Additionally, monitoring occasions of the search spaces 1051, 1061 and 1062 are present in the slot 1006. In this case, the dropping rule may be applied to monitoring occasions of the search spaces 1051 and 1061 which are overlapped in time and associated with different CORESETs. For example, the priority of the search space 1061 may be lower than that of the search space 1051, and thus will be dropped by the terminal device. That is, the terminal device may not monitor the search space 1061 no matter whether the network device transmits DCI in the search space 1061 or not. In the slot 1006, if the reception of PDSCH 1071 occurs prior to the monitoring occasion of the search space 1062, the terminal device may use a beam associated with the latest SS monitoring occasion 1051 for PDSCH reception. However, if the reception of PDSCH 1072 occurs subsequent to the monitoring occasion of the search space 1062, the terminal device may use a beam associated with the latest SS monitoring occasion 1062 for PDSCH reception. In other words, even the reception of PDSCH 1072 may be within a time offset Threshold-Sched-Offset from the search space 1051, the beam used for reception of PDSCH 1072 is associated with the most recent SS monitoring occasion 1062.

According to some embodiments of the present disclosure, the solution for determining the default PDSCH beam can be specified as below: if the offset between the reception of the DL DCI and the corresponding PDSCH is less than a threshold Threshold-Sched-Offset, the terminal device may assume that the DM-RS ports of PDSCH of a serving cell are quasi co-located with the RS(s) in the TCI state with respect to the QCL parameter(s) used for PDCCH QCL indication of the CORESET-ID with the most recent monitoring occasions of search space in the latest slot in which one or more CORESETs within the active BWP of the serving cell are configured for the terminal device with monitoring occasions of search space after applying a search space dropping rule if needed. In this case, if the ‘QCL-TypeD’ of the PDSCH DM-RS is different from that of the PDCCH DM-RS with which they overlap in at least one symbol, the terminal device is expected to prioritize the reception of PDCCH associated with that CORESET. This also applies to the intra-band CA case (when PDSCH and the CORESET are in different component carriers).

In some embodiments of the present disclosure, as shown in FIG. 10, in the slot 1006, if the reception of PDSCH 1071 occurs prior to the monitoring occasion of the search space 1062, the terminal device may use a beam associated with the latest SS monitoring occasion 1051 for PDSCH reception. If the CORESET identifier associated with the search space 1062 is lower than the CORESET identifier associated with the search space 1051 and if the reception of PDSCH 1072 occurs subsequent to the monitoring occasion of the search space 1062, the terminal device may use a beam associated with the latest SS monitoring occasion 1062 for PDSCH reception. However, if the CORESET identifier associated with the search space 1062 is greater than the CORESET identifier associated with the search space 1051, the terminal device may use a beam associated with the search space 1051 for PDSCH reception. In other words, even the reception of PDSCH 1072 may be within a time offset Threshold-Sched-Offset from the search space 1051, the beam used for reception of PDSCH 1072 is associated with the most recent SS monitoring occasion 1062 only if its CORESET identifier is lower than the CORESET identifier associated with the search space 1051.

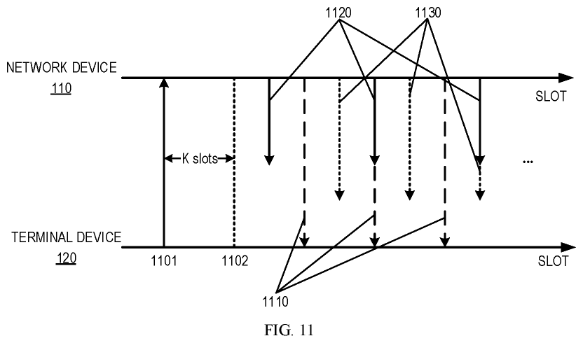

In some cases, if a beam failure occurs and a plurality of search spaces associated with different CORESETs are configured, the BFR-response can be transmitted in any of the plurality of search spaces. FIG. 11 shows an example of such case. As shown in FIG. 11, a search space 1110 is configured to be associated with a BFR-CORESET. Moreover, a CSS 1120 and a USS 1130 for other purposes than BFR are configured. The terminal device 120 may detect a beam failure and transmit a BFR request in a slot 1101. After a slot 1102 (which is later than the slot 1101 by K slots, for example, K=4), the BFR-response may be transmitted in any of the search spaces 1110, 1120 and 1130. Alternatively, or in addition, PDSCH may also be scheduled after the slot 1102 when a new beam for DL reception may have not been configured by the network device 110. In this event, the terminal device 120 may need to determine a beam for DL reception (such as, CORESET/SS/PDSCH reception).

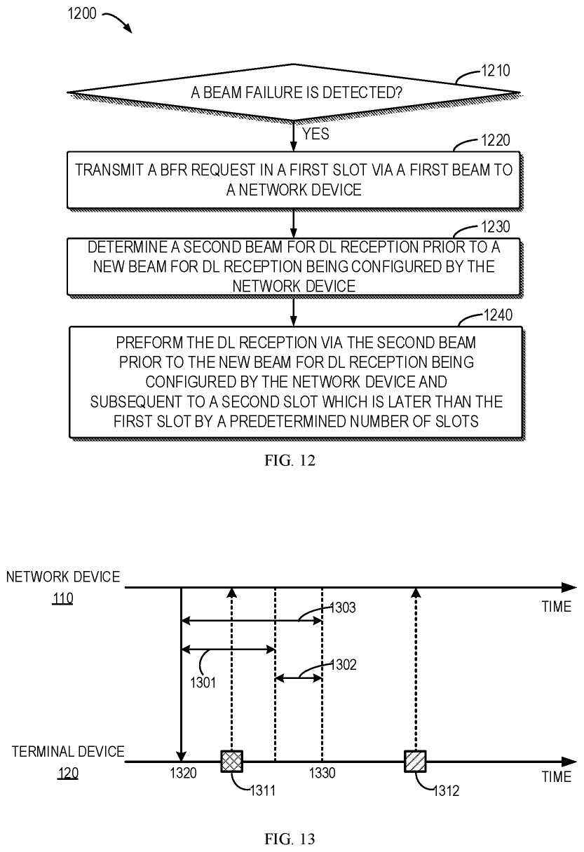

FIG. 12 illustrates a flowchart of an example method 1200 for determining a reception beam according to some embodiments of the present disclosure. The method 1200 can be implemented at the terminal device 120 as shown in FIG. 1. It is to be understood that the method 1200 may include additional blocks not shown and/or may omit some blocks as shown, and the scope of the present disclosure is not limited in this regard. For the purpose of discussion, the method 1200 will be described from the perspective of the terminal device 120 with reference to FIG. 1.

At block 1210, the terminal device 120 determines if a beam failure is detected. In response to a beam failure being detected, at block 1220, the terminal device 120 transmits a BFR request in a first slot via a first beam to the network device 110. For example, as shown in FIG. 11, the first slot is the slot 1101.

At block 1230, the terminal device 120 determines a second beam for DL reception prior to a new beam for DL reception being configured by the network device 110.

At block 1240, the terminal device performs the DL reception via the second beam prior to the new beam for DL reception being configured by the network device 110 in slots subsequent to a second slot which is later than the first slot by a predetermined number of slots. For example, as shown in FIG. 11, the second slot is the slot 1102 which is later than the slot 1101 by K slots (such as, K=4).

In some embodiments, the terminal device 120 may be configured with a first set of SS monitoring occasions for monitoring PDCCH. In this case, the terminal device 120 may apply a search space dropping rule in case that some SS monitoring occasions associated with different CORESETs are overlapped in time. For example, after applying the dropping rule, a second set of SS monitoring occasions may be remained. The terminal device 120 may determine, subsequent to the second slot and from the second set of SS monitoring occasions, an SS monitoring occasion for BFR (for example, the first BFR-SS monitoring occasion). Prior to this determined SS monitoring occasion, the terminal device 120 may use a previous beam indicated by the network device 110 as the second beam for DL reception. Alternatively, or in addition, starting from the determined SS monitoring occasion, the terminal device 120 may use the first beam for transmitting the BFR request as the second beam for DL reception.

Alternatively, in some embodiments, after the second slot or starting from the first BFR-SS monitoring occasion after the second slot and after the dropping rule is applied, the terminal device 120 may determine the second beam for DL reception based on different purposes of search spaces. In some embodiments, for a BFR-SS (for example, the BFR-SS 1110 in FIG. 11), the terminal device 120 may use the first beam for transmitting the BFR request as the second beam for DL reception. For other search spaces (for example, the CSS 1120 and the USS 1130 in FIG. 11), the terminal device 120 may use a previous beam indicated by the network device 110 as the second beam for DL reception. Alternatively, in some embodiments, for the BFR-SS and other search spaces (for example, the search spaces 1110, 1120 and/or 1130 in FIG. 11), a search space dropping rule may be applied. The remained search spaces may be associated with a set of CORESETs. For example, a beam associated with a COREST with the lowest CORESET identifier among the set of CORESETs can be used as the second beam for DL reception.

In some embodiments, subsequent to successfully receiving the BFR-response (that is, DCI) from the network device 110, the terminal device 120 may need to switch the beam for UL transmission. In some embodiments, prior to switching the beam for UL transmission, the terminal device 120 may have to wait for a time duration until the received DCI is decoded successfully and UL data to be transmitted is ready.

FIG. 13 illustrates the timing for switching the beam for UL transmission according to some embodiments of the present disclosure. As shown in FIG. 13, prior to a beam failure, the network device 110 may indicate, to the terminal device 120, a beam 1311 for UL transmission. In response to the beam failure being detected, the terminal device 120 may transmit a BFR request to the network device 110 via another beam 1312, for example. The terminal device 120 may receive a response to the BFR request from the network device 110 at a symbol 1320. Prior to switching the beam for UL transmission, the terminal device 120 has to wait for at least a time duration 1303. That is, before a symbol 1330, the terminal device 120 may use the beam 1311 configured by the network device 110 before the symbol 1320 as the beam for UL transmission. After the symbol 1330, the terminal device 120 may switch the UL beam from the previous beam 1311 to the beam 1312 used for transmitting the BFR request. The time duration 1303 may be determined based on first latency 1301 for decoding the BFR-response (that is, DCI) and second latency 1302 for beam switching and/or UL data preparation.

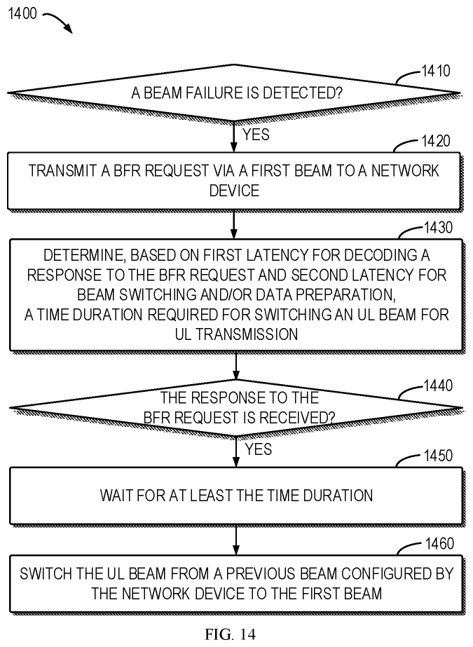

FIG. 14 illustrates a flowchart of an example method 1400 for switching the beam for UL transmission according to some embodiments of the present disclosure. The method 1400 can be implemented at the terminal device 120 as shown in FIG. 1. It is to be understood that the method 1400 may include additional blocks not shown and/or may omit some blocks as shown, and the scope of the present disclosure is not limited in this regard. For the purpose of discussion, the method 1400 will be described from the perspective of the terminal device 120 with reference to FIG. 1.

At block 1410, the terminal device 120 determines if a beam failure is detected. In response to a beam failure being detected, at block 1420, the terminal device 120 transmits a BFR request via a first beam (for example, the beam 1312 in FIG. 13) to the network device 110.

At block 1430, the terminal device 120 determines, based on first latency (for example, the latency 1301 in FIG. 13) for decoding a response to the BFR request and second latency (for example, the latency 1302 in FIG. 13) for beam switching and/or data preparation, a time duration (for example, the time duration 1303 in FIG. 13) required for switching an UL beam for UL transmission. The time duration may be fixed as half of a slot, one slot or two slots. The time duration may be associated with a time duration parameter defined through the PUSCH preparation time L2 in 3GPP NR specifications, or the time offset Threshold-Sched-Offset.

At block 1440, the terminal device 120 determines if the response to the BFR request is received from the network device 110. In response to receiving the response to the BFR request, at block 1450, the terminal device 120 waits for at least the time duration.

At block 1460, the terminal device 120 switches the UL beam for UL transmission from a previous beam (for example, the beam 1311 in FIG. 13) configured by the network device to be the first beam (that is, the beam 1312 in FIG. 13).

Alternatively, or in addition, in some embodiments, in response to receiving from the network device 110 a configuration about a third beam to be used for UL transmission, the terminal device 120 may switch the UL beam from the first beam to the third beam.

According to some embodiments of the present disclosure, the solution for switching the UL beam can be specified as below: after K symbols from a last symbol of a first PDCCH reception in a search space set provided by recoverySearchSpaceId for which the terminal device detects a DCI format with CRC scrambled by C-RNTI or MCS-C-RNTI and until the terminal device receives an activation command for PUCCH-Spatialrelationinfo (in 3GPP specification TS 38.321) or is provided PUCCH-Spatialrelationinfo for PUCCH resource(s), the terminal device transmits a PUCCH using a same spatial filter as for the last PRACH transmission. The value of K should be equal to or greater than the time duration 1303 as shown in FIG. 13.

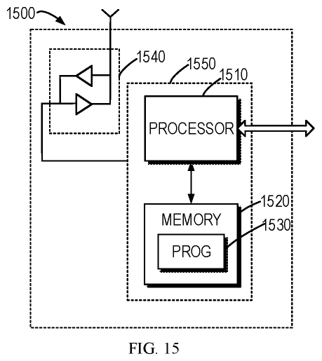

FIG. 15 is a simplified block diagram of a device 1500 that is suitable for implementing embodiments of the present disclosure. The device 1500 can be considered as a further example implementation of a network device 110 or a terminal device 120 as shown in FIG. 1. Accordingly, the device 1500 can be implemented at or as at least a part of the network device 110 or the terminal device 120.

As shown, the device 1500 includes a processor 1510, a memory 1520 coupled to the processor 1510, a suitable transmitter (TX) and receiver (RX) 1540 coupled to the processor 1510, and a communication interface coupled to the TX/RX 1540. The memory 1510 stores at least a part of a program 1530. The TX/RX 1540 is for bidirectional communications. The TX/RX 1540 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1530 is assumed to include program instructions that, when executed by the associated processor 1510, enable the device 1500 to operate in accordance with the embodiments of the present disclosure, as discussed herein with reference to FIGS. 1 to 14. The embodiments herein may be implemented by computer software executable by the processor 1510 of the device 1500, or by hardware, or by a combination of software and hardware. The processor 1510 may be configured to implement various embodiments of the present disclosure. Furthermore, a combination of the processor 1510 and memory 1510 may form processing means 1550 adapted to implement various embodiments of the present disclosure.

The memory 1510 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1510 is shown in the device 1500, there may be several physically distinct memory modules in the device 1500. The processor 1510 may be of any type suitable to the local technical network, and may include one or more of general purpose computers, special purpose computers, microprocessors, digital signal processors (DSPs) and processors based on multicore processor architecture, as non-limiting examples. The device 1500 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 4-7, 9, 12 and 14. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1.-33. (canceled)

34. A method implemented at a terminal device, comprising:
receiving, from a network device serving the terminal device, information on a plurality of search spaces associated with a control resource set configured for beam failure recovery (BFR);
in response to a beam failure being detected, transmitting a BFR request to the network device; and
monitoring a response to the BFR request in the plurality of search spaces.

35. The method of claim 34, wherein the plurality of search spaces include a first search space and a second search space,
wherein the first search space is one of a common search space and a UE-specific search space, and
wherein the second search space is a UE-specific search space.

36. The method of claim 34, wherein the plurality of search spaces include a first search space, and wherein receiving information on the plurality of search spaces comprises:
receiving first information on the first search space from the network device, the first information indicating at least one of a first time periodicity, a first time offset and a first set of control channel elements associated with the first search space.

37. The method of claim 34, wherein the plurality of search spaces are associated with different time periodicities, different time offsets and/or different sets of control channel elements.

38. The method of claim 34, wherein the plurality of search spaces include a common search space (CSS) and a UE-specific search space (USS), and wherein monitoring a response to the BFR request comprises:
monitoring a response to the BFR request in a first DCI format in the CSS, the first DCI format being one of DCI format 0_0 and DCI format 1_0; and
monitoring the response to the BFR request in a second DCI format in the USS, the second DCI format being one of DCI format 0_0 and DCI format 1_0, or one of DCI format 0_1 and DCI format 1_1.

39. The method of claim 34, wherein the plurality of search spaces include a first USS and a second USS, and wherein monitoring a response to the BFR request comprises:
monitoring a response to the BFR request in a third DCI format in the first USS, the third DCI format being one of DCI format 0_0 and DCI format 1_0; and
monitoring the response to the BFR request in a fourth DCI format in the second USS, the fourth DCI format being one of DCI format 0_1 and DCI format 1_1.

40. A method implemented at a terminal device, comprising:
in response to a beam failure being detected, transmitting a beam failure recovery (BFR) request in a first slot via a first beam to a network device serving the terminal device;
determining a second beam for downlink (DL) reception prior to a new beam for DL reception being configured by the network device; and
performing the DL reception via the second beam prior to the new beam for DL reception being configured by the network device and subsequent to a second slot which is later than the first slot by a predetermined number of slots.

41. The method of claim 40, wherein the terminal device is configured with a first set of search space (SS) monitoring occasions for monitoring Physical Downlink Control Channel (PDCCH), and wherein determining the second beam comprises:
in response to a plurality of SS monitoring occasions from the first set of SS monitoring occasions being overlapped in time and associated with different control resource sets (CORESETs), determining, from the first set of SS monitoring occasions, a second set of SS monitoring occasions by applying a dropping rule to the plurality of SS monitoring occasions;
determining, subsequent to the second slot and from the second set of SS monitoring occasions, an SS monitoring occasion for BFR; and
prior to the determined SS monitoring occasion, determining a previous beam indicated by the network device as the second beam for DL reception.

42. The method of claim 41, further comprising:
starting from the determined SS monitoring occasion, determining the first beam as the second beam for DL reception.

43. The method of claim 40, wherein the terminal device is configured with a first SS monitoring occasion for BFR, and wherein determining the second beam comprises:
determining the first beam as the second beam for DL reception during the first SS monitoring occasion.

44. The method of claim 43, wherein the terminal device is configured with a second SS monitoring occasion different from the first SS monitoring occasion, and wherein determining the second beam comprises:
determining a previous beam indicated by the network device as the second beam for DL reception during the second SS monitoring occasion.

45. The method of claim 40, wherein the terminal device is configured with a first set of CORESETs and a first set of SS monitoring occasions associated with the first set of CORESETs, and wherein determining the second beam comprises:
in response to a plurality of SS monitoring occasions from the first set of SS monitoring occasions being overlapped in time and associated with different CORESETs, determining, from the first set of SS monitoring occasions, a second set of SS monitoring occasions by applying a dropping rule to the plurality of SS monitoring occasions, the second set of SS monitoring occasions being associated with a second set of CORESETs included in the first set of CORESETs;
selecting, from among the second set of CORESETs, a CORESET with the lowest CORESET identifier; and
determining a beam associated with the selected CORESET as the second beam.

46. A method implemented at a terminal device, comprising:
in response to a beam failure being detected, transmitting a beam failure recovery (BFR) request via a first beam to a network device serving the terminal device;
determining, based on first latency for decoding a response to the BFR request and second latency for beam switching and/or data preparation, a time duration required for switching an uplink (UL) beam for UL transmission;
in response to receiving the response to the BFR request from the network device, waiting for at least the time duration; and
switching the UL beam for UL transmission from a previous beam configured by the network device to be the first beam.

47. The method of claim 46, further comprising:
in response to receiving from the network device a configuration about a third beam to be used for UL transmission, switching the UL beam from the first beam to the third beam.
